(19) United States
(12) Patent Application Publication
(10) Pub. No.: US 2013/0152053 A1
(43) Pub. Date: Jun. 13, 2013

(54) COMPUTER MEMORY ACCESS MONITORING AND ERROR CHECKING

(71) Applicants: Weidong Cui, Redmond, WA (US); David Molnar, Seattle, WA (US); Sang Kil Cha, Pittsburgh, PA (US)

(72) Inventors: Weidong Cui, Redmond, WA (US); David Molnar, Seattle, WA (US); Sang Kil Cha, Pittsburgh, PA (US)

(73) Assignee: Microsoft Corporation, Redmond, WA (US)

(21) Appl. No.: 13/316,582

(22) Filed: Dec. 12, 2011

(51) Int. Cl. G06F 9/44

(52) U.S. Cl. 717/127

(57) ABSTRACT

Computer memory access monitoring and error checking systems and processes are disclosed herein. In one embodiment, a computer implemented method includes executing a computer program having a first object in a first memory location and having a value corresponding to a second memory location holding a second object. The method also includes, during a memory read from the second memory location, performing a comparison of a first version of the first memory location and a second version of the second memory location. The method further includes determining if an error exists in the computer program based on the comparison between the first version and the second version.

### BACKGROUND

Software bugs generally refer to errors, flaws, mistakes, and/or other faults in computer programs that can produce incorrect or unexpected results. For example, some software bugs may cause a computer to crash or freeze because of memory access violation, memory leaks, or other types of defects. Other software bugs may allow attackers to take control of other users' computers, to spy on other users, and/or otherwise injure unsuspecting users.

Programming mistakes and errors are believed to cause most software bugs. Various debugging techniques have been developed to discover such mistakes and errors. Examples of such debugging techniques include code coverage testing, fault injection, mutation testing, fuzz testing, and exploratory testing. However, these debugging techniques may still be unsuitable and/or ineffective for catching various types of software bugs.

### SUMMARY

Aspects of the present technology are directed to computer testing systems and processes for testing and/or debugging computer programs. In certain embodiments, the present technology may include techniques to discover use-after-free bugs, type confusion bugs, and/or other types of software bugs. In other embodiments, the present technology may also include techniques to at least facilitate and/or assist in debugging computer programs.

In one aspect, the present technology provides a computer testing system that includes an initial processing component and a runtime component. The initial processing component can insert testing instructions into a computer program. The runtime component can then execute the computer program with the inserted instructions and monitor a type, a version, and/or other suitable characteristics of individual objects of the executed computer program in a computer memory (e.g., heap, stack, etc.).

In certain embodiments, the testing system may assign a unique version (or identifier) to memory locations holding the individual objects and/or corresponding pointers. When the computer program dereferences a pointer during execution, the testing system may compare (1) a version of the dereferenced pointer location (i.e., the pointer version) to (2) a version of an object in the memory location pointed by the pointer (i.e., the object version). If the pointer version does not match the object version, the testing system may raise and/or record an alarm for use-after-free bugs.

In other embodiments, the testing system may associate and record a type for individual objects in the computer memory. For example, the testing system may associate an integer, floating point, and/or other suitable type with a particular memory location holding a structure or parameter. During execution, the testing system may compare the types of memory locations referred to by a source operand or destination operand. If the types of the memory locations do not match, the testing system may raise and/or record an alarm or flag for type confusion bugs.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a schematic block diagram illustrating a computer testing system in accordance with embodiments of the present technology.

FIGS. 2A and 2B are flow diagrams illustrating processes for testing a computer program in the computer testing system of FIG. 1.

FIG. 3 is a schematic block diagram illustrating a type module suitable for the computer testing system in FIG. 1 in accordance with embodiments of the present technology.

FIG. 4A is a flow diagram illustrating a process for performing a type check in accordance with embodiments of the present technology.

FIG. 4B is a flow diagram illustrating a process for inspecting a source operand in accordance with embodiments of the present technology.

FIG. 4C is a flow diagram illustrating a process for inspecting a destination operand in accordance with embodiments of the present technology.

FIG. 5 is a schematic block diagram illustrating a version module suitable for the computer testing system in FIG. 1.

FIG. 6 is a flow diagram illustrating a process for performing a version check in accordance with embodiments of the present technology.

### DETAILED DESCRIPTION

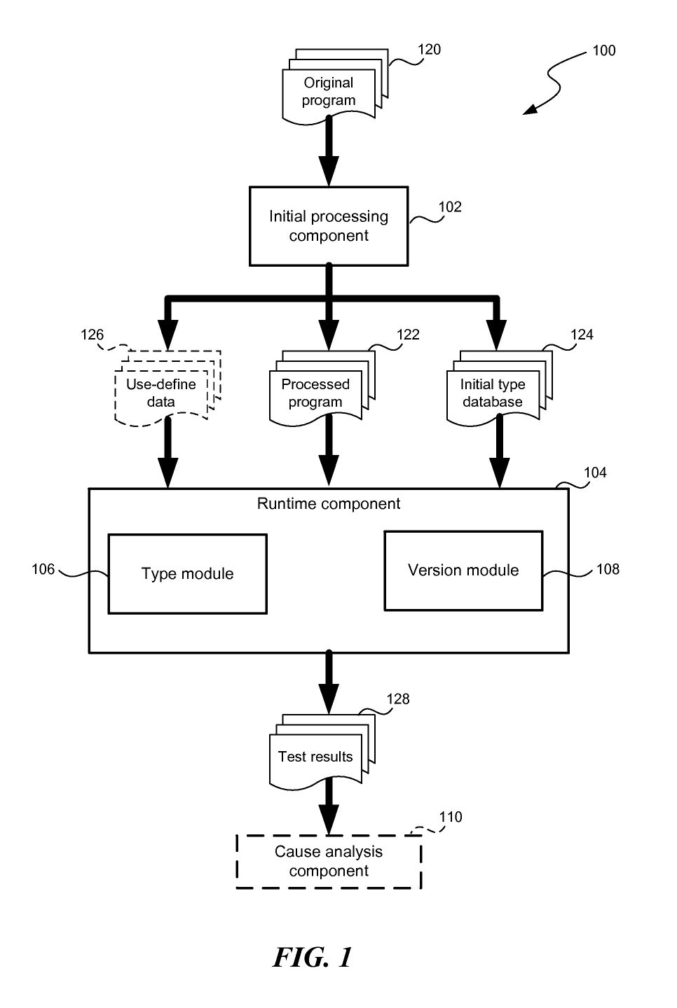

Various embodiments of computer testing systems, components, modules, routines, and processes are described below. In the following description, example software codes, values, and other specific details are included to provide a thorough understanding of various embodiments of the present technology. A person skilled in the relevant art will also understand that the technology may have additional embodiments. The technology may also be practiced without several of the details of the embodiments described below with reference to FIGS. 1-6.

As discussed in the Background section, software bugs can cause computer programs to produce incorrect or unexpected results. One type of such software bug is a type confusion bug that occurs when a program assigns a source operand of a particular type (e.g., integer) to a destination operand of a different type (e.g., floating). Another type of software bug is a use-after-free bug that occurs when a program reuses a memory location after the memory location has been de-allocated. The following text describes certain embodiments of type checking and version checking techniques that a user may apply to address at least some of the foregoing software bugs. In other embodiments, a user may apply the described techniques for addressing other suitable types of software bugs.

FIG. 1 is a schematic block diagram illustrating software components of a computer testing system 100. In FIG. 1 and in other Figures hereinafter, individual software components, modules, and routines may be a computer program, procedure, or process written as source code in C, C++, Java, and/or other suitable programming languages. The computer program, procedure, or process may be compiled into object or machine code and presented for execution by a processor of a personal computer, a network server, a laptop computer, a smart phone, and/or other suitable computing devices. Various implementations of the source and/or object code and associated data may be stored in a computer memory that includes read-only memory, random-access memory, magnetic disk storage media, optical storage media, flash memory devices, and/or other suitable storage media excluding propagated signals.

As shown in FIG. 1, the computer testing system 100 may include an initial processing component 102, a runtime component 104, and an optional cause analysis component 110 operatively coupled to one another. In one embodiment, a single computer device may execute all of the foregoing components of the computer testing system 100. In other embodiments, at least one of the foregoing components may be executed in a distributed computing environment. Even though FIG. 1 only shows the foregoing components, in further embodiments, the computer testing system 100 may also include a display component, an input/output component, and/or other suitable components based on particular applications.

The initial processing component 102 may be configured to insert test instructions into an original program 120. The original program 120 with the inserted test instructions forms a processed program 122 for execution by the runtime component 104. In certain embodiments, the test instructions may be added for monitoring a function entry, function return, memory read, memory write, dynamic memory allocation, and/or dynamic memory de-allocation. In other embodiments, the test instructions may also be added for monitoring usage of memory, usage of particular instructions, and/or frequency and duration of function calls.

In one embodiment, the original program 120 may be in source code (e.g., C++). The initial processing component 102 may include a source code editor configured to add the test instructions to the original program 120. The initial processing component 102 may also include a compiler configured to compile the original program 120 with the added test instructions to generate the processed program 122 in object or machine code. In one example, Microsoft Visual Studio provides both a suitable source code editor and a compiler when the source code of the original program 120 is in C or C++.

In another embodiment, the original program 120 may be in object or machine code. The initial processing component 102 may include a binary instrumentation tool configured to add the test instructions in binary form to the original program 120 to generate the processed program 122. One suitable binary instrumentation tool is Pin provided by Intel Corp. of Santa Clara, Calif.

In further embodiments, a user may determine that the original program 120 includes a first portion in source code and a second portion in object code. In one embodiment, the user may compile the first portion of the original program 120 into object code before the test instructions are added using the binary instrumentation tool. In other embodiments, the user may process the first portion using the source code editor and compiled with the compiler. The user may then process the second portion with the binary instrumentation tool and subsequently combine it with the compiled first portion having the added test instructions.

The initial processing component 102 may also be configured to identify and collect type information for static variables, function parameters, local variables, structures, and/or other objects in the original program 120. As used herein, the phrase “type” generally refers to a classification identifying at least one of various categories of data. The classification may determine possible values for a type, operations that may be performed on values of the type, and the way values of the type may be stored. In one example, a type may include a primitive type, e.g., floating-point, integer, Boolean, etc. In other examples, a type may include a program-defined type or types. In further examples, a type may include a combination of and/or nested primitive and program-defined types.

In one embodiment, the initial processing component 102 may be configured to collect the type data from information generated by a compiler/debugger during compilation of the original program 120. For instance, if the original program 120 is in C or C++ and is compiled with Microsoft Visual Studio, the initial processing component 102 may collect the type information from a program database (“PDB”) file generated by the compiler. For example, the original program 120 may include the following C statement:
struct A *pA=(struct A*) malloc(sizeof(struct A));
   where struct A is a program-defined structure type. Based on information in the PDB file, the initial processing component 102 may determine that pointer pA has a value pointed to an address for storing an object with the type of struct A. In other embodiments, the initial processing component 102 may collect the type data from symbolic information, user input, and/or other suitable sources.

The initial processing component 102 may also be configured to associate the collected type information with individual objects of the original program 120. In the illustrated embodiment, the objects and type data are organized and stored in an initial type database 124. For example, in the example instruction above, the initial type database 124 can store the memory location of the object pA with the type struct A*. In other embodiments, the objects and the collected type information may be organized and/or stored in other suitable data structures.

Optionally, the initial processing component 102 may be configured to identify and generate use-define data 126 (e.g., use-define chains, shown in phantom lines for clarity) of function parameters, local variables, structures, and/or other objects in the original program 120. As used herein, the phrase “use-define data” generally refers to data that include a use of a variable and all the definitions of the variable that can reach the use without any other intervening definitions.

In one embodiment, the initial processing component 102 is configured to perform a static use-define analysis on the original program 120. For example, the original program 120 may include the following machine code instructions:

mov eax, [ebp-8]
mov ebx, [ebp-4]
add ebx, 4
mov ecx, [ebx]
mov ebx, eax
add ebx, 0
push ecx
mov ecx, [ebx]

As shown above, the use-define analysis shows that is the variable ebx is used in “mov ecx, [ebx]” and is defined by memory location [ebp-8] as shown in a use-define chain below:
[ebx]←eax←[ebp-8]
   The initial processing component 102 may then record both the value of [ebx], eax, and [ebp-8] as an entry in the use-define data 126. In other embodiments, the initial processing component 102 may be configured to use other suitable techniques for collecting the use-define data 126 from user input and/or other suitable sources.

The runtime component 104 is configured to (a) receive the processed program 122, the initial type database 124, and the optional use-define data 126 and (b) execute the processed program 122 to generate test results 128. As shown in FIG. 1, in the illustrated embodiment, the runtime component 104 includes a type module 106 and a version module 108. In other embodiments, the runtime component 104 may include only one of the type module 106 and the version module 108. In further embodiments, the runtime component 104 may include other suitable modules in addition to, or in lieu of, the type module 106 and the version module 108.

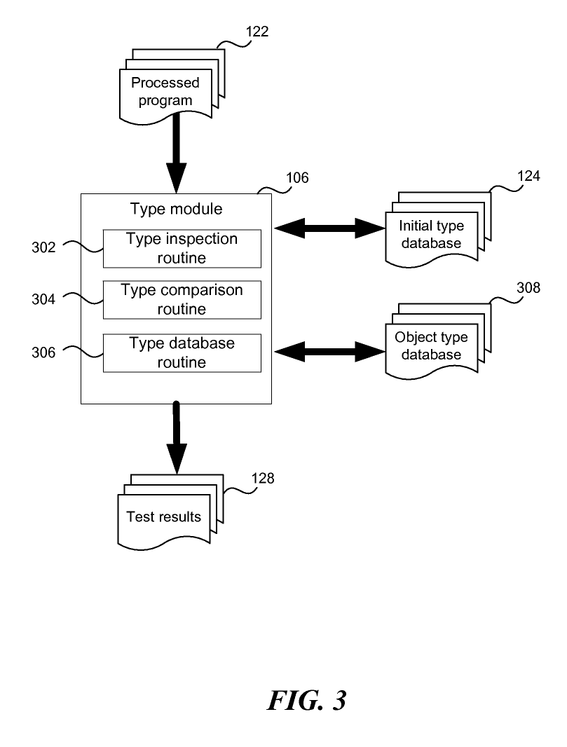

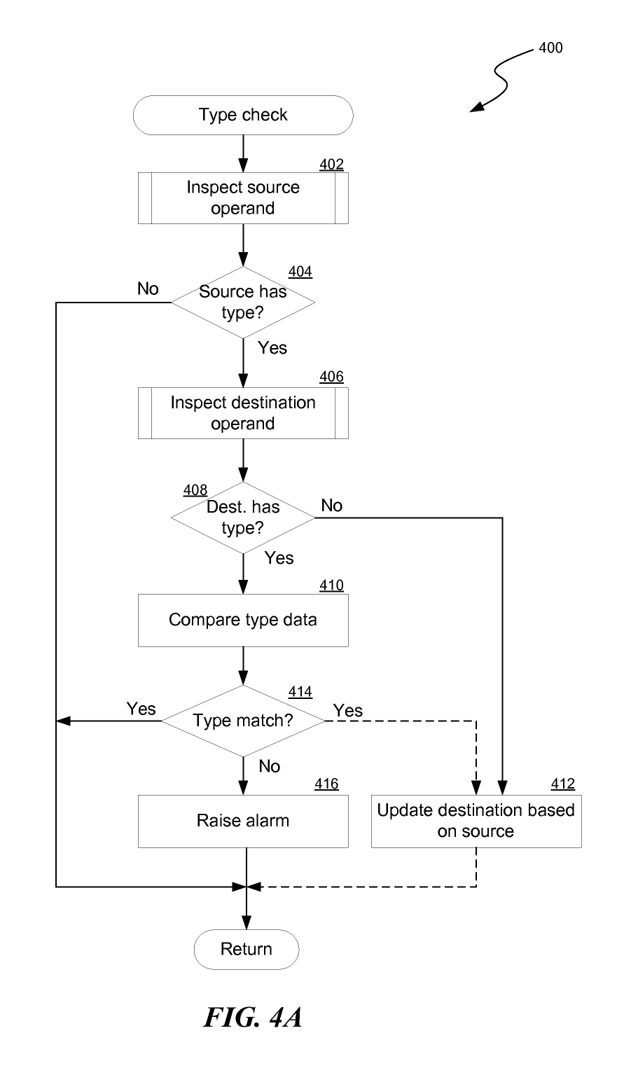

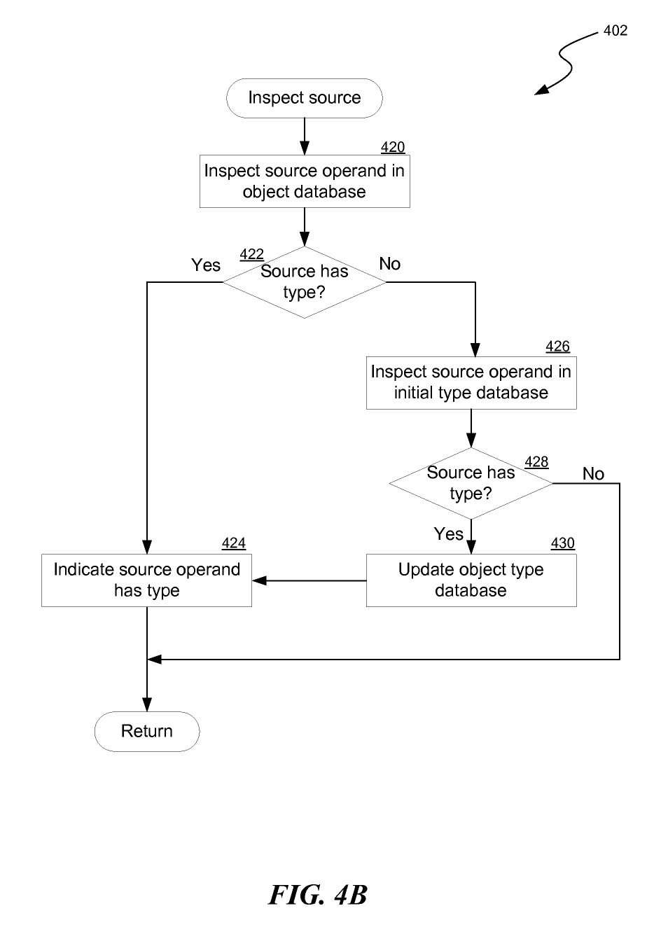

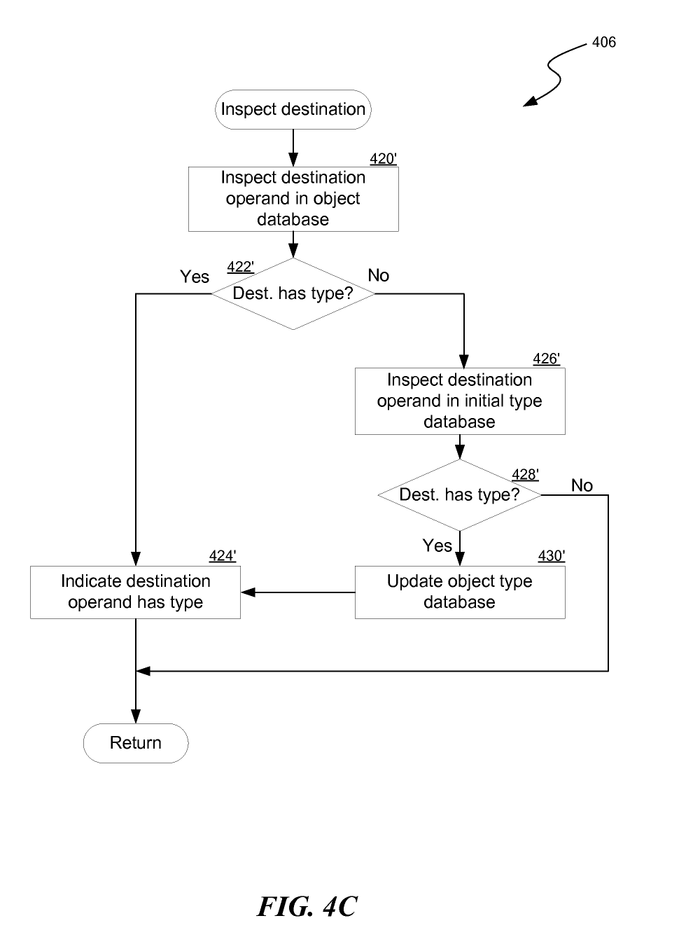

The type module 106 may be configured to associate a type with individual memory locations holding objects when the processed program 122 is executed. For example, the type module 106 may associate an integer, floating point, and/or other suitable type with a memory location holding a particular structure or parameter. The type module 106 may compare the type of the particular memory location holding the structure or parameter with that of a source (or destination) operand location. If the types do not match, the type module 106 may raise and/or record an alarm or flag for a type confusion bug. Embodiments of the type module 106 and the foregoing type checking techniques are described in more detail below with reference to FIGS. 3-4C.

The version module 108 may be configured to assign a unique version to individual memory locations holding objects and corresponding pointers. As used herein, the word “version” generally refers to a unique identifier. For example, the version may include globally unique identifiers, sequential numbers, random numbers, or random alphanumeric codes assigned individually to each memory location. In other examples, the version may include other suitable identifiers.

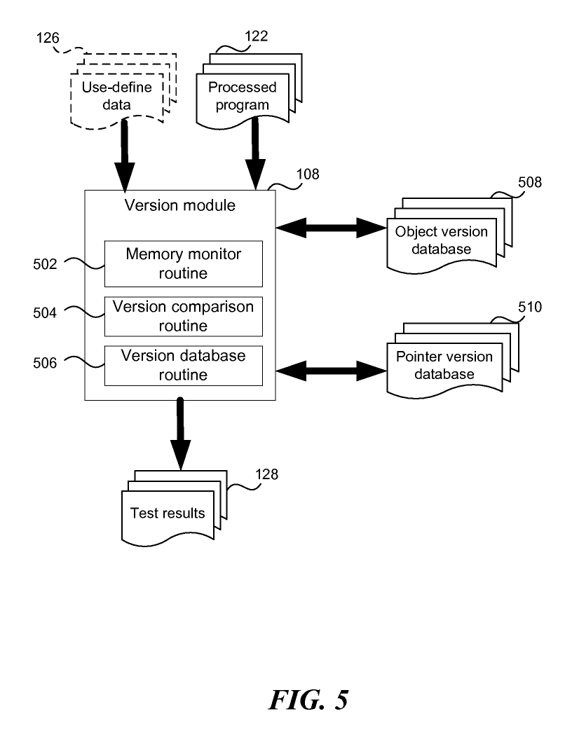

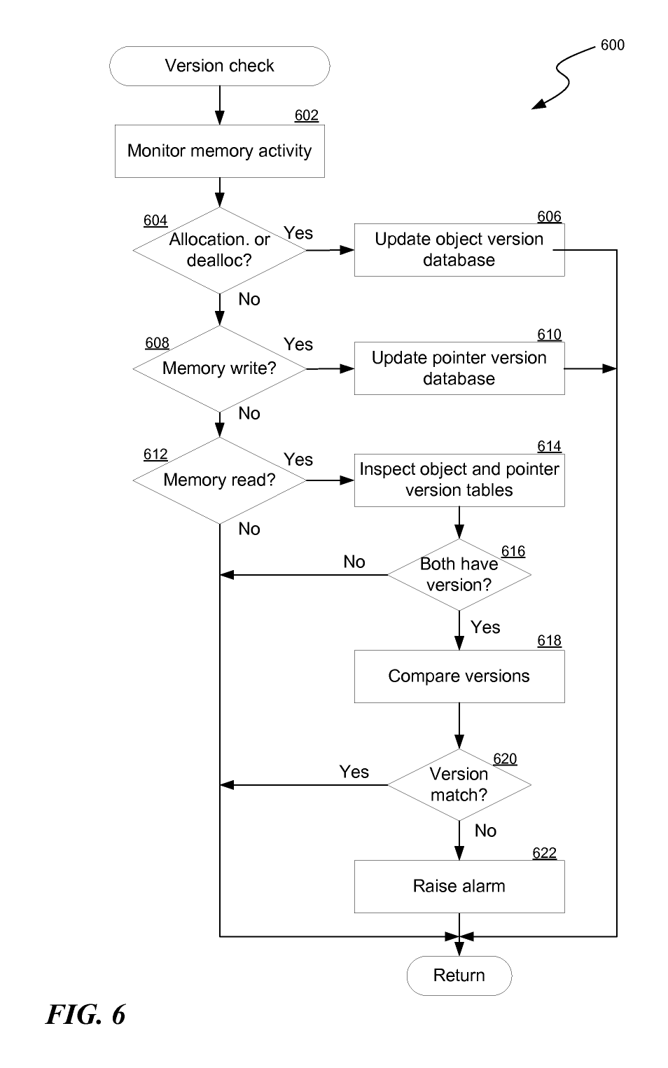

The assigned versions may then be used during runtime for finding use-after-free bugs. For example, in certain embodiments, the version module 108 can compare (1) the version of the memory location holding the dereferenced pointer (i.e., the pointer version) to (2) a current version the object in the memory location pointed to by the pointer (i.e., the object version) when a pointer is dereferenced. If the pointer version does not match the object version, the version module 108 may raise and/or record an alarm for use-after-free bugs. Embodiments of the version module 108 and the foregoing version checking techniques are described in more detail below with reference to FIGS. 5 and 6.

In other embodiments, the computer testing system 100 may optionally include a cause analysis component 110. The cause analysis component 110 may be configured to analyze test results 128 from at least one of the type module 106 and the version module 108 and provide at least an estimate or general indication of the cause of a particular software bug. The cause analysis component 110 may include instructions for software tracing, event logging, and/or other suitable instructions. In the illustrated embodiment, the cause analysis component 110 is independent from the runtime component 104. In other embodiments, the cause analysis component 110 may be integral to the runtime component 104. In further embodiments, the cause analysis component 110 may be omitted.

In operation, the initial processing component 102 may perform a static analysis on the original program 120. During the static analysis, the initial processing component 102 inserts test instructions into the original program 120 to generate the processed program 122, identifies and collects initial type information for objects in the original program 120, and optionally generates use-define data 126 for objects in the original program 120. In other embodiments, the initial processing component 102 may perform the foregoing functions dynamically or in a just-in-time fashion.

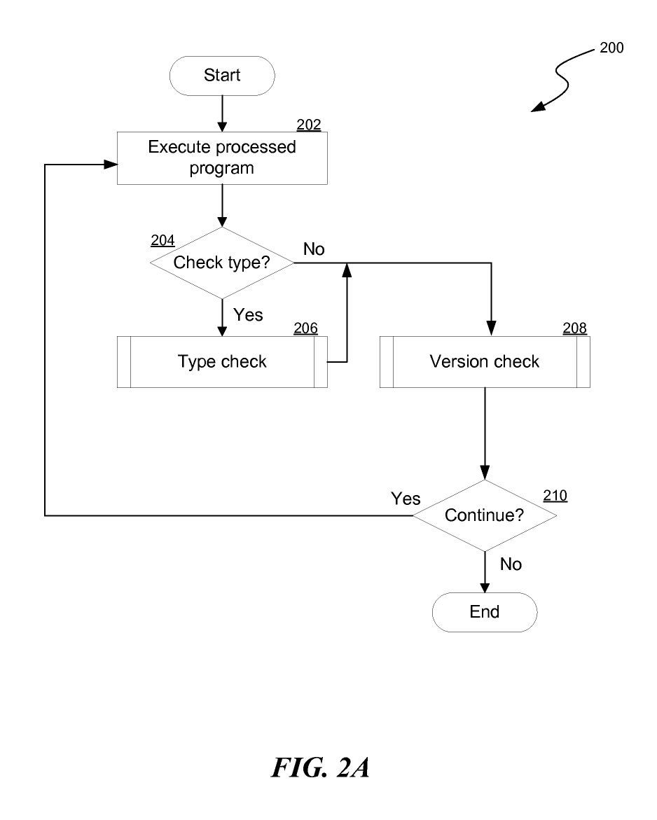

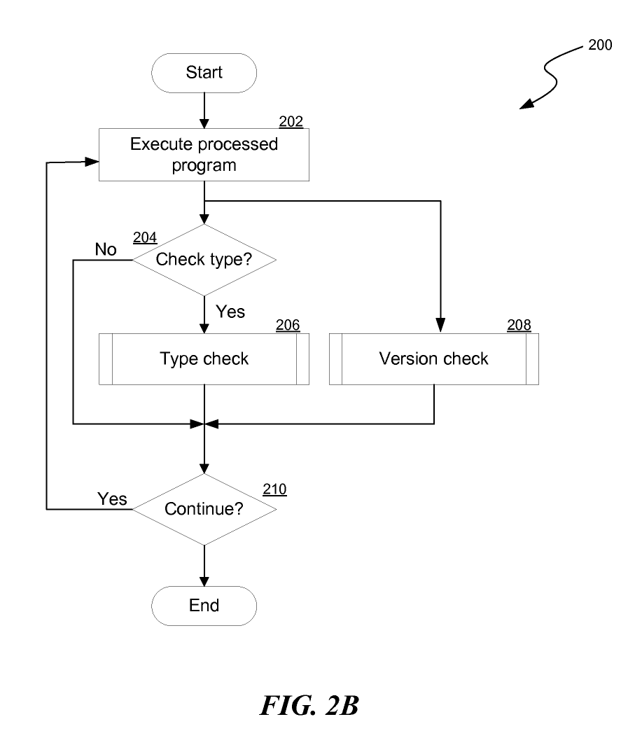

The runtime component 104 then executes the processed program 122 to check for type confusion errors, use-after-free errors, and/or other errors in the original program 120. In one embodiment, the runtime component 104 uses the use-define data 126 for version checking. In other embodiments, the use-define data 126 may be omitted. Instead, the initial processing component 102 may be configured to insert instructions for monitoring register moves in the processed program 122 during runtime. The optional cause analysis component 110 may then analyze, suggest, or identify a cause of the individual errors in the original program 120. Embodiments of operation of the runtime component 104 are described in more detail below with reference to FIGS. 2A and 2B.

FIG. 2A is a flow diagram illustrating a process 200 for testing a computer program with the runtime component 104 of the computer testing system 100 in FIG. 1. As shown in FIG. 2A, the process 200 includes a block 202 of executing an instruction of the processed program 122 (FIG. 1). For example, the executed instruction may include a function entry, a memory read, a memory write, an assignment, and/or other suitable types of instruction.

The process 200 also includes a decision block 204 to determine whether to perform a type check. In one embodiment, the process 200 may perform a type check on every executed instruction. As a result, the block 204 may be omitted. In other embodiments, the process 200 may perform a type check on some instructions based on certain conditions. For example, in one embodiment, if the executed instruction does not involve a memory operation, the process 200 may determine that a type check is not needed. In another example, if both a source operand and a destination operand of an assignment instruction have a matching type, the process 200 may determine that a type check is not needed. As used herein, a “source operand” generally refers to an object whose value is to be assigned to another object (referred to as the “destination operand”). In further embodiments, the determination may be based on other suitable conditions.

If a type check is to be performed, the process 200 proceeds to performing a type check on the executed instruction at block 206. Embodiments of performing a type check are described in more detail below with reference to FIGS. 4A-4C. After performing the type check or if a type check is not to be performed, the process 200 proceeds to performing a version check at block 208. Embodiments of performing a version check are described in more detail below with reference to FIG. 6.

The process 200 then includes a decision block 210 to determine whether the process should continue. In one embodiment, the process 200 continues if the processed program 122 includes additional instructions. In other embodiments, the process 200 may continue based on other suitable conditions. As a result, the process reverts to executing another instruction of the processed program 122 at block 202. Otherwise, the process ends.

Even though FIG. 2A shows performing a type check and a version check in sequence, in other embodiments, the process 200 may include performing a type check and a version check in parallel, as shown in FIG. 2B. In further embodiments, the process 200 may include performing a type check and a version check in an interleaved fashion and/or other suitable fashion. In further embodiments, the process 200 may perform a type check or a version check but not both.

FIG. 3 is a schematic block diagram illustrating details of the type module 106 of the computer testing system 100 in FIG. 1. As shown in FIG. 3, the type module 106 can include a type inspection routine 302, a type comparison routine 304, and a type database routine 306 operatively coupled to the initial type database 124 and an object type database 308. Even though FIG. 3 shows only the foregoing routines, in other embodiments, the type module 106 may also include input/output routines and/or other suitable types of routines.

The type inspection routine 302 may be configured to check and determine whether a source or destination operand has a type in at least one of the initial type database 124 and the object type database 308. As described above, the initial type database 124 can include type information for function parameters, local variables, structures, and/or other objects in the processed program 122. Similarly, the object type database 308 can include type information for memory locations allocated to objects in the processed program 122. For example, in one embodiment, the object type database 308 can include the following data records:

| Memory address | Type |
|---|---|
| [value 1] | struct A |
| [value 2] | struct B |

Thus, as shown above, each memory address (e.g., [value 1] or [value 2]) identifies a memory location that is associated with a type (e.g., struct A or struct B). In other embodiments, the object type database 308 may be organized and/or stored in other suitable data structures.

The type comparison routine 304 may be configured to compare types of a source operand and a destination operand and determine if the compared types match. For example, in one embodiment, the type comparison routine 304 may be configured to determine if the type of the source operand exactly matches that of the destination operand. In another embodiment, the type comparison routine 304 may be configured to reduce the type of at least one of the source operand and the destination operand into a set of primitive data types (e.g., integer, floating point, Boolean, etc.) and their respective type locations (e.g., bit offset) in the source and/or destination operand. The type comparison routine 304 may then determine whether the set of the source operand is a subset of that of the destination operand at the same type locations, or vice versa. In further embodiments, the type comparison routine 304 may be configured to compare types based on other suitable rules determined by a user, a programming language, and/or other suitable sources. Results from the type comparison routine 304 may then be stored in the test results 128.

The type database routine 306 may be configured to organize records, including the initial type database 124 and the object type database 308, and facilitates storing and retrieving of these records. Any type of database organization may be utilized, including a flat file system, hierarchical database, relational database, or distributed database, such as provided by a database vendor such as the Microsoft Corporation of Redmond, Wash.

FIG. 4A is a flow diagram illustrating a process 400 for performing a type check in accordance with embodiments of the present technology. As described above with reference to FIGS. 2A and 2B, the process 400 may be a subroutine of the process 200 of FIG. 2A or 2B during execution of an instruction (e.g., a function entry) in the processed program 122 (FIG. 1). As shown in FIG. 4A, the process 400 includes inspecting a source operand for type data (referred to herein as a “source type”) with the type inspection routine 302 (FIG. 3) at block 402. Embodiments of inspecting the source operand are described in more detail below with reference to FIG. 4B. The process 400 may then include a decision block 404 to determine whether the source type is available in at least one of the object type database 308 (FIG. 3) and the initial type database 124 (FIG. 3). If the source type is not available, the process returns.

If the source type is available, the process 400 proceeds to inspecting a destination operand with the type inspection routine 302 at block 406. Embodiments of inspecting the destination operand are described in more detail below with reference to FIG. 4C. The process 400 may then include a decision block 408 to determine whether the destination operand has type data (referred to herein as a “destination type”).

If the destination type is not available, the process 400 proceeds to updating the destination type in the object type database 308 (FIG. 3) based on the source type at block 412. In one embodiment, the destination type may be inferred based on the source type. In other embodiments, the destination type may be associated with a subset of the source type. In further embodiments, the destination type may be associated with the source type following rules determined by a user, a programming language, and/or other suitable sources.

If the destination type is available, the process 400 then includes comparing the destination type with the source type using the type comparison routine 304 (FIG. 3) at block 410. The process 400 may then include a decision block 414 to determine if the source type and the destination type match. In one embodiment, if the source type and the destination type match, the process 400 may indicate an error does not exist before the process returns. In other embodiments, the process 400 can optionally include updating the destination type in the object type database 308 based on the source type at block 412 before the process returns.

If the source type and the destination type do not match, the process 400 includes raising an alarm at block 416 to indicate that a type mismatch error has occurred. As a result, a type confusion bug may exist in the executed instruction. The process 400 may then include storing the alarm in the test results 128 (FIG. 3) for further analysis.

FIG. 4B is a flow diagram illustrating a process 402 for inspecting the source operand in accordance with embodiments of the present technology. As shown in FIG. 4B, an initial stage of the process 402 includes inspecting the source operand in the object type database 308 (FIG. 3). In one embodiment, the type database routine 306 (FIG. 3) may query the object type database 308 based on a memory address and/or other suitable parameters of the source operand. In other embodiments, the type database routine 306 may also retrieve records associated with the source operand from the object type database 308.

The process 402 may then include a decision block 422 to determine whether the source type is available in the object type database 308. If the source type is available in the object type database 308, the process 402 proceeds to indicating that the source type is available at block 424. Then, the process returns.

If the source type is not available in the object type database 308, the process 402 includes inspecting the source operand in the initial type database 124 (FIG. 3). In one embodiment, the type database routine 306 may query the initial type database 124 based on a symbol, a memory address, and/or other suitable characteristics of the source operand. In other embodiments, the type database routine 306 may also retrieve records associated with the source operand from the initial type database 124.

The process 402 may then include a decision block 428 to determine whether the source type is available in the initial type database 124. If the source type is available in the initial type database 124, the process 402 includes updating the source type in the object type database 308 with the retrieved records from the initial type database 124 at block 430. In one embodiment, the source type in the object type database 308 may be updated with the same records from the initial type database 124. In other embodiments, the source type may be updated with a subset of the records from the initial type database 124. In further embodiments, the source type in the object type database 308 may be associated with select records from the initial type database 124 following rules determined by a user, a programming language, and/or other suitable sources. The process 402 proceeds to indicating that the source type is available at block 424, and then the process returns.

FIG. 4C is a flow diagram illustrating a process 406 for inspecting a destination operand in accordance with embodiments of the present technology. As shown in FIG. 4C, the process 406 includes operations that are generally similar to those of the process 402 except the source operand is replaced with the destination operand in the process 406. As a result, operations of the process 406 are identified with the same numbers as the corresponding operations of the process 402 in FIG. 4B but with an apostrophe. Detailed description of the process 406 is omitted for clarity.

FIG. 5 is a schematic block diagram illustrating details of the version module 108 of the computer testing system 100 in FIG. 1. As shown in FIG. 5, the version module 108 can include a memory monitor routine 502, a version comparison routine 504, and a version database routine 506 operatively coupled to an object version database 508 and a pointer version database 510. Even though FIG. 5 shows the foregoing routines, in other embodiments, the version module 108 may also include input/output routines and/or other suitable types of routines.

The memory monitor routine 502 may be configured to monitor and/or determine memory operations when the processed program 122 is executed. For example, in one embodiment, the memory monitor routine 502 can be configured to monitor at least one of function entry, function return, memory read, memory write, dynamic memory allocation, and dynamic memory de-allocation. In other embodiments, the memory monitor routine 502 may be configured to monitor other suitable memory operations.

The version comparison routine 504 is configured to compare a version of a dereferenced pointer (i.e., the pointer version) to a version of an object in the memory location pointed to by the pointer (i.e., the object version). If the pointer version does not match the object version, the version comparison routine 504 may raise and/or record an alarm for use-after-free bugs.

The version database routine 506 is configured to organize records, including the optional use-define data 126, the object version database 508, and the pointer version database 510, and facilitates storing and retrieving of these records. Any type of database organization may be utilized, including a flat file system, hierarchical database, relational database, or distributed database, such as provided by a database vendor such as the Microsoft Corporation of Redmond, Washington.

The object version database 508 can include version data for memory locations holding objects allocated to the corresponding memory locations. For example, in one embodiment, the object version database 508 can include the following data record:

| Object address | Version |
|---|---|
| [value 1] | 1 |

Similarly, the pointer version database 510 can include a data structure as follows:

| Pointer address | Version |
|---|---|
| [value 2] | 1 |

Thus, in the example above, the object address in the object version database 508 has a value of the pointer (e.g., P). The pointer address in the pointer version database 510 has a value that is the memory address holding the pointer P, i.e., &P. In other embodiments, at least one of the object version database 508 and the pointer version database 510 may have other suitable types of data structures.

FIG. 6 is a flow diagram illustrating a process 600 for performing a version check in accordance with embodiments of the present technology. As described above with reference to FIGS. 2A and 2B, the process 600 may be a subroutine of the process 200 of FIG. 2A or 2B during execution of an instruction (e.g., a function entry) in the processed program 122 (FIG. 1). As shown in FIG. 6, an initial stage 602 of the process 600 includes monitoring memory activity with the memory monitor routine 502 (FIG. 5) when the processed program 122 (FIG. 5) is executed. The process 600 may then include a decision block 604 to determine whether the executed instruction involves a memory allocation or de-allocation for an object. If a memory allocation or de-allocation is detected, the process 600 includes updating the object version database 508 (FIG. 5) with a unique version value for the allocated (or de-allocated) object at block 606. Then, the process returns. If a memory allocation or de-allocation is not detected, the process 600 proceeds to another decision block 608 to determine whether the instruction involves a memory write associated with a pointer to the object.

If a memory write is detected, the process 600 includes updating the pointer version database 510 with a unique version value for the pointer based on the version value for the object at block 610. In one embodiment, the version values are equal to each other. In other embodiments, the version values may have other relationships. Then, the process returns. If a memory write is not detected, the process 600 proceeds to another decision block 612 to determine whether the executed instruction involves a memory read or dereferencing a pointer. If a memory read is not detected, the process returns.

If a memory read is detected, the process 600 proceeds to inspecting both the object version database 508 (FIG. 5) and the pointer version database 510 (FIG. 5) with the version database routine 506 (FIG. 5) to determine if both the pointer and the object pointed by the pointer have version values. In one embodiment, the process 600 may include accessing the use-define data 126 (FIG. 5) to locate a memory location for the pointer (i.e., &P). For instance, in the use-define example discussed above with referenced to FIG. 1, ebx may represent the value of pointer P. Then, based on the use-define chain [ebx]←eax←[ebp-8], the memory location containing the value of pointer P (i.e., &P) is [ebp-8]. In other embodiments, the process 600 may include performing a sequence of register moves during runtime to determine &P. In further embodiments, the process 600 may determine &P based on other suitable techniques.

Based on the memory location for the pointer &P, the version database routine 506 may query the pointer version database 510 to determine if a version value is present for &P. Based on the value of the pointer (i.e., P), the version database routine 506 may query the object version database 508 to determine if a version value is present for P.

The process 600 may include a decision block 616 to determine if the memory locations for both the object and the pointer have version values. If at least one of the version values is not present, the process returns. If both the version values are present, the process 600 proceeds to comparing the version values to each other at block 618. The process 600 may then include another decision block 620 to determine whether the version values match. In one embodiment, the version values are indicated as a match if they are equal to each other. In other embodiments, the version values may be indicated as a match based on rules determined by a user, a programming language, and/or other suitable sources. If the version values match, the process returns. If the version values do not match, the process 600 includes raising an alarm at block 622. The alarm may be stored in the results 128 (FIG. 5) for further analysis.

Several embodiments of the process 600 may at least facilitate finding use-after-free bugs in the original program 120 (FIG. 1). For example, the original program 120 may include the following code:

int *A = malloc( sizeof(int) ); //line 1
free ( A ); //line 2
int *B = malloc( sizeof(int) ); //line 3
*A = 0x42; //line 4

At line 1, a memory location is allocated to an integer with pointer A. As a result, the process 600 assigns both the object at the memory location and pointer A with a first version (e.g., 1) at blocks 604 and 608. At line 2, the memory location is freed and may be allocated again. At line 3, the same memory location is re-allocated to an integer with pointer B. Thus, the process 600 assigns a second version (e.g., 2) to both the object at the memory location and pointer B.

At line 4, a memory read is attempted using pointer A. At this point, the version values of pointer A, pointer B, and the object at the memory location 0x42 are as follows:

Pointer A: 1
Pointer B: 2
Object at memory location: 2

Thus, when the process 600 compares the first version (i.e., 1) of pointer A to the second version (i.e., 2) of the object at the memory location at block 620, a mismatch is detected. As a result, the process 600 may raise an alarm at block 622 and indicate that the original program 120 attempts to access a memory location with a pointer that has been freed.

The version module 108 (FIG. 5) and the version checking process 600 are described above with separate object version database 508 and pointer version database 510 for purposes of convenience. In certain embodiments, the object version database 508 and the pointer version database 510 may be combined into one database (not shown) with cross references of object-pointer pairs. In further embodiments, the pointer version database 510 may include another object version database. In yet further embodiments, the version module 108 may include other databases (not shown) in addition to, or in lieu of, the object version database 508 and the pointer version database 510.

Specific embodiments of the technology have been described above for purposes of illustration. However, various modifications may be made without deviating from the foregoing disclosure. In addition, many of the elements of one embodiment may be combined with other embodiments in addition to or in lieu of the elements of the other embodiments. Accordingly, the technology is not limited except as by the appended claims.

I/We claim:

1. A computer implemented method, comprising:
executing an instruction of a computer program with a processor, the executed instruction having a source operand and a destination operand in a computer memory coupled to the processor;
determining if the source operand and the destination operand have a source type and a destination type, respectively;
if the source operand and the destination operand have the source type and the destination type, respectively, performing a comparison of the source type and the destination type; and
determining if an error exists in the computer program based on the comparison between the source type and the destination type.

2. The computer implemented method of claim 1 wherein determining if the source operand and the destination operand have a source type and a destination type includes:
determining if the source type exists in an object type database, the object type database containing type data generated during execution of the computer program; and
if the source operand has a source type in the object type database, indicating the source operand has the source type.

3. The computer implemented method of claim 1 wherein determining if the source operand and the destination operand have a source type and a destination type includes:
determining if the source type exists in an object type database, the object type database containing type data generated during execution of the computer program;
if the source type does not exist in the object type database, determining if the source type exists in an initial type database, the initial type database containing type data collected from a compiler and/or debugger used to compile and/or debug the computer program; and
if the source type exists in the initial type database, updating the object type database based on the source type in the initial type database and indicating the source operand has the source type.

4. The computer implemented method of claim 1 wherein determining if the source operand and the destination operand have a source type and a destination type includes:
determining if the destination type exists in an object type database, the object type database containing type data generated during execution of the computer program; and
if the destination operand has a destination type in the object type database, indicating the destination operand has the destination type.

5. The computer implemented method of claim 1 wherein determining if the source operand and the destination operand have a source type and a destination type includes:
determining if the destination type exists in an object type database, the object type database containing type data generated during execution of the computer program;
if the destination type does not exist in the object type database, determining if the destination type exists in an initial type database, the initial type database containing type data collected from a compiler and/or debugger used to compile and/or debug the computer program; and
if the destination type exists in the initial type database, updating the object type database based on the destination type in the initial type database and indicating the destination operand has the destination type.

6. The computer implemented method of claim 1 wherein determining if an error exists includes:
determining if the source type matches the destination type;
if the source type do not match the destination type, indicating an error exists in the computer program.

7. The computer implemented method of claim 1 wherein determining if an error exists includes:
reducing the source type and the destination type to a source set of primitive types and a destination set of primitive types with respective type locations;
determining if the source set is a subset of the destination set or if the destination set is subset of the source set at the individual type locations;
if the source set is a subset of the destination set or the destination set is a subset of the source set, indicating an error does not exist in the computer program; and
if the source set is not a subset of the destination set and the destination set is not a subset of the source set, indicating an error exists in the computer program.

8. The computer implemented method of claim 1, further comprising if the source operand has a source type but the destination operand does not have a destination type, updating the destination type based on the source type.

9. The computer implemented method of claim 1 wherein determining if an error exists includes:
determining if the source type matches the destination type; and
if the source type and the destination type match, updating the destination type based on the source type.

10. A computer implemented method, comprising:
executing a computer program with a processor, the executed computer program having a first object in a first memory location of a computer memory coupled to the processor, the first object having a value corresponding to a second memory location holding a second object;
during a memory read from the second memory location, performing a comparison of a first version of the first memory location and a second version of the second memory location; and
determining if an error exists in the computer program based on the comparison between the first version and the second version.

11. The computer implemented method of claim 10, further comprising:
monitoring activity of the computer memory; and
if the monitored activity indicates a memory read from the second memory location, performing the comparison of the first version of the first memory location and the second version of the second memory location.

12. The computer implemented method of claim 10, further comprising:
monitoring activity of the computer memory; and
if the monitored activity indicates a memory allocation of the second object, assigning the second version to the second memory location.

13. The computer implemented method of claim 10, further comprising:
monitoring activity of the computer memory;
if the monitored activity indicates a memory allocation of the second object, assigning the second version to the second memory location; and
if the monitored activity indicates a memory write to the first memory location with the value, assigning the first version to the first memory location, the first version being equal to the second version.

14. The computer implemented method of claim 10 wherein performing a comparison includes:
determining if the first version and the second version exist; and
if the first version and the second version exist, performing the comparison of the first version of the first memory location and the second version of the second memory location.

15. The computer implemented method of claim 10 wherein determining if an error exists includes if the first version does not equal to the second version, indicate an error exists in the computer program.

16. A computer testing system, comprising:
an initial processing component configured to
insert test instructions into an original program to produce a processed program, the test instructions being configured to monitor at least one of a function entry, function return, memory read, memory write, dynamic memory allocation, and dynamic memory de-allocation;
identify and collect type data for a plurality of objects in the original program;
associate a type with individual objects in the original program based on the collected type data;
organize and store the objects with associated types in an initial type database;
a runtime component configured to receive the processed program from the initial processing component and execute the received processed program, the runtime component including a type module and a version module, wherein
the type module is configured to
determine if a first object and a second object have a first type and a second type, respectively, based at least in part on the stored objects with the associated types in the initial type database;
if the first object and the second object have the first type and the second type, respectively, perform a comparison of the first type and the second type; and
indicate a type confusion error exists in the original program if the first type does not match the second type;
the first object is in a first memory location and the second object is in a second memory location;
the version module is configured to
monitor activity of the computer memory with the test instructions;
during a memory read from the second memory location, perform a comparison of a first version of the first memory location and a second version of the second memory location when the first object has a value corresponds to the second memory location; and
determining if a use-after-free error exists in the original program based on the comparison between the first version and the second version.

17. The computer testing system of claim 16 wherein:
the initial processing component is also configured to perform a use-define analysis on the original program to generate a use-define chain; and
the version module is also configured to determine the first memory location of the first object based on the generated use-define chain.

18. The computer testing system of claim 16 wherein the type module and the version module are configured to:
record the type confusion error and/or the use-after-free error; and
the computer testing system further includes a cause analysis component configured to analyze the recorded type confusion error and/or use-after-free error and to provide an estimate of a cause of the type confusion error and/or the use-after-free error.

19. The computer testing system of claim 16 wherein the type module includes:
a type inspection routine configured to determine whether the first object has the first type at least in the initial type database;
a type comparison routine configured to perform a comparison of the first type and the second type; and
a type database routine configured to organize records in the initial type database and to facilitate storing and retrieving of these records.

20. The computer testing system of claim 16 wherein the version module includes:
a memory monitor routine configured to monitor activity of the computer memory and to indicate at least one of memory allocation, memory de-allocation, memory read, and memory write;
a version comparison routine configured to compare the first and second versions; and
a version database routine configured to organize records in a version database in which one of the first and second versions is stored.
